(19) United States
(12) Patent Application Publication
(10) Pub. No.: US 2009/0064320 A1
(43) Pub. Date: Mar. 5, 2009

(54) Image processing apparatus and image processing system

(75) Inventors: Yuji Okamoto, Kyoto (JP); Naofumi Ueda, Kyoto (JP)

Correspondence Address: Edwards Angell Palmer & Dodge LLP, P.O. Box 55874, Boston, MA, 02205, US

(73) Assignee: Sharp Kabushiki Kaisha, Osaka (JP)

(21) Appl. No.: 12/214,759

(22) Filed: Jun. 20, 2008

(30) Foreign Application Priority Data
Jun. 27, 2007 (JP) 2007-168319
Jun. 27, 2007 (JP) 2007-169617
Jun. 29, 2007 (JP) 2007-171668

(51) Int. Cl. H04L 9/32; G06F 13/00

(52) U.S. Cl. 726/19

(57) ABSTRACT

An image processing apparatus and an image processing system, in which burdensome operation for user authentication is unnecessary, are provided.

The image processing system comprises an image processing apparatus A and an information processing apparatus B capable of communicating with each other. The image processing apparatus A is provided with an image detecting section 1, an image processing section 2, a printing section 3, a storage section 4, and a control section 5. The control section 5 includes an authenticating section 6. The information processing apparatus B is provided with an inputting section 10, a display section 11, and a control section 12. The inputting section 10 includes a detecting section 15 for detecting an image of the user's finger as user information.

In the configuration above, the user inputs operation information from the inputting section 10 so that the detecting section 15 obtains the image of the finger of the user and the control section 5 performs an authentication of the user from the obtained image of the finger.

### BACKGROUND OF THE INVENTION

1. Field of the Invention

The present invention relates to an image processing apparatus and an image processing system for performing user authentication to perform image processing.

2. Description of the Related Art

In an image processing apparatus, user authentication is performed to prevent confidential information from being leaked by unauthorized uses. Generally, the user authentication is performed before the start of use and the use of the image processing apparatus is allowed after the authentication. As described in Japanese Patent Laid-Open Nos. 11-149345, 2007-058540, and 2001-143077, the authentication is performed based on the inputted user information. The input of the user information is performed by special operation which is different from normal operation, such as inputting of a password or reading of finger print. Japanese Patent Laid-Open No. 2005-327116 discloses a copying machine including an accounting apparatus, in which both of the accounting apparatus and the copying machine include user authentications and the user authentication in the side of the copying machine is also used as a start button.

Moreover, after the authenticated user has used the image processing apparatus, special operation for the log-out is required. By the user authentication, accounting in the unit of a department is performed, or releasing of access limitation, transmission limitation, and the like by security setting is performed. If the log-out is not performed when the user gets away from the image processing apparatus, the next user is able to use the image processing apparatus in the logged-on state. Therefore, there is a risk that accounting is carried out in spite of not using it, or that confidential information stored in the image processing apparatus is taken out.

As described above, the user authentication requires special operation other than normal operation, which is burdensome for the user. Moreover, at the time of the log-out as well, special operation is required, and there is a risk that this operation is forgotten to be performed. That is, there is a problem of the security.

In view of the above described circumstance, it is an object of the present invention to provide an image processing apparatus and an image processing system, in which there is no need of performing burdensome operation for the user authentication.

### SUMMARY OF THE INVENTION

In order to achieve the foregoing object, the present invention comprises a processing apparatus for processing image data, an operating apparatus which is operated by a user to instruct processing in the processing apparatus, and a control apparatus capable of communicating with the processing apparatus and the operating apparatus, in which the operating apparatus has a detecting section for obtaining user information of the user while the user is operating the operating apparatus, and the control apparatus performs authentication of the user based on the user information.

The user inputs the instruction of the processing in the processing apparatus from the operating apparatus. In this case, the operating apparatus obtains the user information of the user from the detecting section. That is, the operating apparatus obtains the user information of the user by the detecting section while the user is inputting the instruction of the processing in the processing apparatus. Then, the operating apparatus outputs the user information together with the instruction of the processing to the control apparatus.

The control apparatus performs the authentication of the user based on the inputted user information. After the user has been authenticated, the control apparatus outputs the instruction to the processing apparatus, and the processing apparatus performs the processing based on the inputted instruction. After the user has not been authenticated, the control apparatus inhibits the processing.

The operating apparatus has an inputting section that the user touches, and the detecting section is provided in the inputting section. The detecting section detects an image of a finger of the user, which has depressed the inputting section. The operating apparatus outputs the instruction in accordance with contents of the operated inputting section to the control apparatus and outputs the image of the finger of the user as the user information to the control apparatus.

The operating apparatus obtains the image of the finger of the user, which is in contact with the operating apparatus, while the user is performing operation setting of the processing apparatus. The obtained image of the finger is adapted to be the user information. The user information is information specific to the user. By using the user information, it is made possible that the control apparatus specifies the user during operation to authenticate the user. The user is only performing normal operation and there is not need of performing operation for the authentication, thus the troublesomeness is eliminated.

As the detecting section, an image pickup device is provided in the inputting section, and the detecting section obtains the image of the finger of the user, which is in contact with the inputting section. The control apparatus performs the authentication every time the user performs operation. When setting processing for one job, operation is required to be performed plurality of times. Therefore, the authentication is performed a plurality of times.

Moreover, the control apparatus is provided in the processing apparatus or the operating apparatus. Alternatively, a management server is provided and the control apparatus is provided therein. When the control apparatus is provided in the management server, the operating apparatus, the control apparatus, and the processing apparatus perform each of corresponding processing, respectively.

When it is detected based on the inputted user information that the user has been replaced, the control section determines whether allowing or inhibiting the use depending on the replaced user. Every time the user performs operation, the operating section detects user information. When different user information is inputted, the control section determines that the user has been replaced. In this case, the control section determines whether or not the replaced user can be authenticated, and the use is allowed after the user has been authenticated, and the use is inhibited after the user has not been authenticated. Moreover, the use may be inhibited even when the replaced user can be authenticated.

The control section performs the authentication of the user in the unit of a job. Therefore, the control section performs a log-out after the end of one job. When a next job is performed after the end of one job, authentication of the user is newly performed. It can be prevented that another user uses the authentication of the former user to perform a job.

When a predetermined time has passed from the last operation, the control section cancels the input from the operating section. When the operating user gets away from the processing apparatus, a situation that the predetermined time passes after the last operation occurs. In this case, the input is canceled, and thereby the past authentication of the user is invalidated. It can be prevented that another user uses the processing apparatus based on the past authentication.

The present invention comprises a processing section for processing image data, an operating section for setting operation of the processing section, and a control section for controlling the processing section depending on input from the operating section, in which the operating section detects user information from a user while the user is performing operation, and the control section performs authentication of the user based on the user information.

According to the configuration above, it is possible to perform the user authentication for each job without requiring burdensome operation for the user, such as user authentication before the start of using the apparatus and the log-out after operation.

Specifically, the operating section has a display section for performing display for operation on a screen and a detecting section for detecting an image of an object on the screen. The operating section detects a position where the user has pointed, inputs instruction in accordance with contents displayed on the position to the control section, and inputs an image of an operating hand of the user as the user information to the control section.

As the specific configuration, for example, the operating section detects a part of the user's hand putted on the screen. That is, the operating section has the display section for performing the display for operation on the screen and the detecting section for detecting the image of the object on the screen, and has a function of a display and a scanner. The operating section inputs the instruction in accordance with the contents displayed on the position where the user has operated to the control section, and inputs the image of the operating hand of the user as the user information to the control section. The detected image is adapted to be the user information.

The user information is information specific to the user. By using the user information, it is made possible that the control section specifies the user during operation to authenticate the user. The user is only performing normal operation and there is not need of performing operation for the authentication, thus the troublesomeness is eliminated.

As another configuration, the operating section is provided with an execution key for performing determination of operation input and instruction to execute operation, and a user authenticating section which is operated by key operation of the execution key. The execution key functions as a last operation key for each job, and the user authentication is performed by the operation of the execution key.

For example, without performing user authentication before the start of using the image processing apparatus, the image processing apparatus can perform inputting of setting such as the copy quantity and variable magnification settings to the image processing apparatus, and by depressing the execution key (start key), the image processing apparatus performs authentication of finger print by an image pickup device such as a CCD (charge coupled device) provided in the execution key, and authenticates that the user is a allowed user so as to start the processing.

The control section performs the authentication of the user every time the user performs operation. When setting processing for one job, operation is required to be performed a plurality of times. Therefore, the authentication is performed a plurality of times.

When it is detected based on the inputted user information that the user has been replaced, the control section determines whether allowing or inhibiting the use depending on the replaced user. The operating section detects the user information every time the user performs operation. When different user information is inputted, the control section determines that the user has been replaced. In this case, the control section determines whether or not the replaced user can be authenticated, and the use is allowed when the replaced user can be authenticated, and the use is inhibited when the replaced user can not be authenticated. Moreover, the use may be inhibited even when the replaced user can be authenticated.

The control section performs the authentication of the user in the unit of a job. Therefore, the control section performs the log-out after the end of one job. When a next job is performed after the end of one job, authentication of the user is newly performed. It can be prevented that another user uses the authentication of the former user to perform a job.

When a predetermined time has passed from the last operation, the control section cancels the input from the operating section. Moreover, when the start key is operated within the predetermined time from the last operation, the control section performs the processing. When the operating user gets away from the processing apparatus, a situation that the predetermined time passes after the last operation can occur. In this case, the input is canceled, and thereby the past authentication of the user is invalidated. It can be prevented that another user uses the image processing apparatus based on the past authentication.

According to the configuration above, by performing the user authentication by the input operation of the instruction by the user, it is made possible that the control apparatus always performs the user authentication before executing the processing. Further, since the user authentication is automatically released after the execution of the processing, the control apparatus can surely perform the user authentication in the unit of a job.

### BRIEF DESCRIPTION OF THE DRAWINGS

FIG. 1 is a block diagram showing the schematic configuration of an image processing system according to a first embodiment of the present invention;

FIG. 2 is block diagram of an image processing apparatus and an information processing apparatus;

FIG. 3 is a perspective view of an inputting section;

FIG. 4 shows an input key in detail;

FIG. 5 is a flowchart of user authentication;

FIG. 6 is a block diagram showing the schematic configuration of an image processing system according to a second embodiment;

FIG. 7 is block diagram of an image processing apparatus and an information processing apparatus;

FIG. 8 is a block diagram showing the schematic configuration of an image processing system according to a third embodiment;

FIG. 9 is a block diagram of an image processing apparatus, an information processing apparatus, and a management server;

FIG. 10 is a block diagram showing the schematic configuration of an image processing apparatus according to a fourth embodiment;

FIG. 11 shows a screen for operation displayed on an input display;

FIG. 12 is a flowchart of user authentication;

FIG. 13 is a block diagram showing the schematic configuration of an image processing system according to a fifth embodiment;

FIG. 14 shows an operating section;

FIG. 15 is an enlarged view of execution buttons; and

FIG. 16 is a flowchart of user authentication.

### DETAILED DESCRIPTION OF THE PREFERRED EMBODIMENTS

### First Embodiment

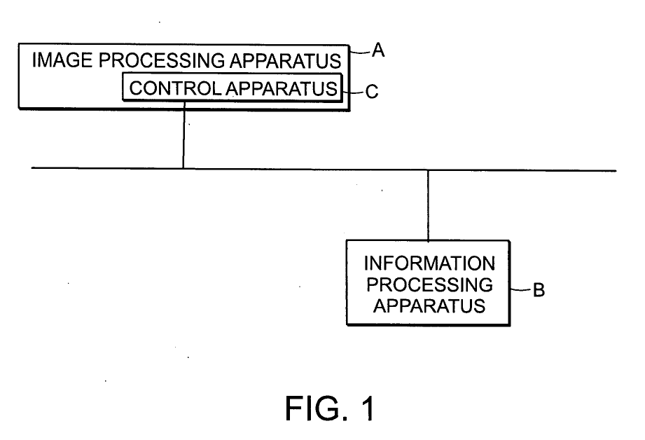

As shown in FIG. 1, an image processing system of a first embodiment comprises an image processing apparatus A serving as a processing apparatus, and an information processing apparatus B serving as an operating apparatus for giving instruction to the image processing apparatus A.

Each of the image processing apparatus A and the information processing apparatus B is connected to a network such as a LAN, a WAN, and the Internet. Thereby, data transmission/reception between each of the apparatuses is performed through the network.

The information processing apparatus B, which is a terminal apparatus such as a PC used by the user, is provided with an inputting section 10 such as a keyboard and a mouse, a display section 11, a control section 12 for carrying out control of the apparatus as a whole, and a network control section 13 for performing communication with the image processing apparatus A or other image processing apparatuses. The information processing apparatus B functions as an operating apparatus which is operated by the user.

The display section 11 is made up of a liquid crystal display and displays the inputted contents, and the operation state in the whole of the image processing apparatus A. The network control section 13 is a communication section for performing communication with external apparatuses including other image processing apparatuses and an information processing apparatus such as a PC, and is connected to the external apparatuses through the network or a telephone line.

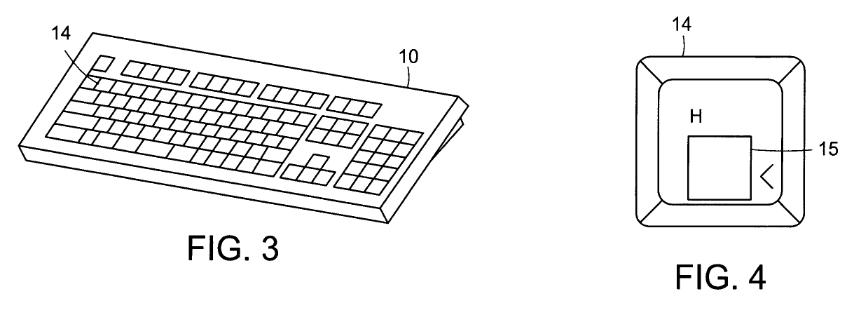

As shown in FIGS. 3 and 4, the inputting section 10, which is a keyboard including various kinds of input keys 14, performs inputting of operation information such as operation instructions and various kinds of settings. The input key 14 is provided with a detecting section 15, at the center of the upper face thereof, for detecting an image of a finger of the user, which has depressed the input key 14. The detecting section 15 is configured to be an image sensor (CCD) and reads the image of the finger of the user quickly. The read image of the finger is outputted to the control section 12.

On the other hand, when performing the touch-typing on the keyboard serving as the inputting section 10, the user depresses each of the input keys 14 with specific fingers. Then, in consideration of its characteristic, the detecting section 15 is provided in the specific input key 14 so as to obtain an image of the specific finger of the user. For example, the detecting section 15 is disposed in the input key 14 of “H”. Normally, the “H” is depressed with the right index finger. That is, the detecting section 15 surely detects an image of the right index finger.

Moreover, the detecting section 15 is not particularly limited to be provided in the input key 14 of “H”. For example, it may be provided in the “space key” which is depressed with thumbs of both hands or in “F” which is depressed with the left index finger. Further, it may be included in a plurality of input keys 14. Alternatively, it may be provided in a mouse or a joy stick which is one type of inputting sections.

The control section 12, which is a CPU including a storage section such as a RAM and a ROM, controls each section based on a program which is stored in the storage section. The control section 12 extracts finger print information from the obtained image of the finger. Specifically, the control section 12 specifies the outline of the finger from the obtained image of the finger to determine an area with the finger print based on the specified outline of the finger. Then, the control section 12 extracts the determined area as the finger print information. The control section 12 outputs the extracted finger print information and operation information inputted by the user to a control section 5 of the image processing apparatus A through the network control section 13.

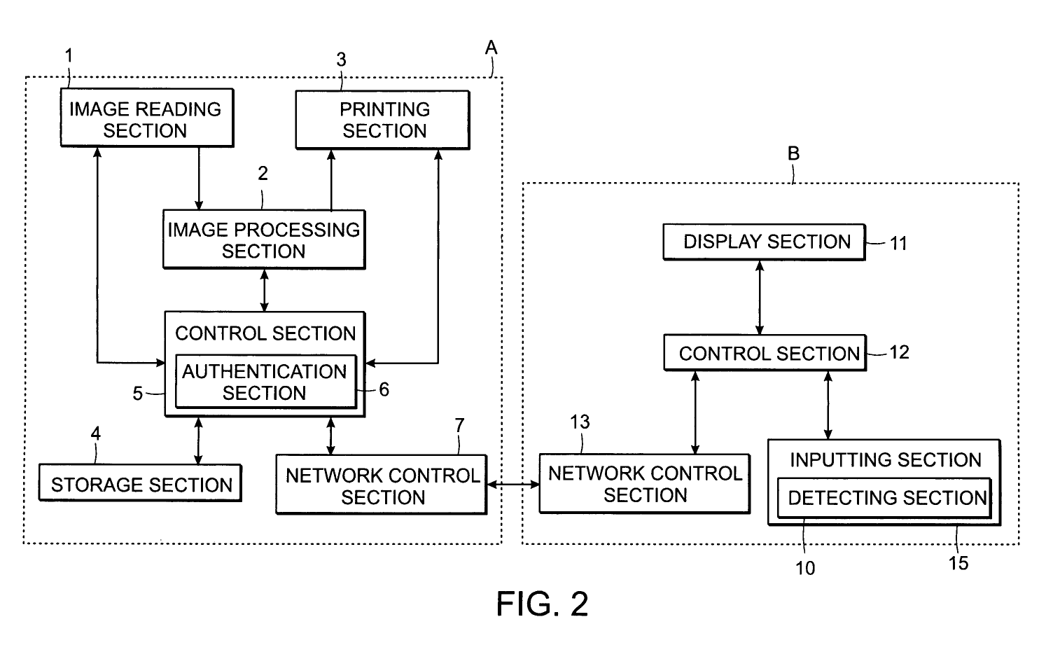

The image processing apparatus A is a multifunctional peripheral for performing processing such as copying, printing, facsimile communication, and document filing. The image processing apparatus A has a control apparatus C for performing authentication of user information. As shown in FIG. 2, the image processing apparatus A is provided with an image detecting section 1 for reading an image of a document, an image processing section 2 for carrying out predetermined image processing for the read and inputted image, a printing section 3 for printing the image on the recording sheet, a storage section 4 for storing user information, and the control section 5 for controlling execution of processing with respect to the image.

The storage section 4 is made up of a hard disc apparatus. The storage section 4 stores user information of each user. The user information is inputted and stored by an administrator of the present image processing system in advance. The user information is subjected to encryption processing to be stored. When the user information is read from the storage section 4, the user information is subjected to decryption processing and outputted to the control section 5.

Moreover, the stored user information is finger print information of the index finger or the middle finger of the specific user. Further, a security level for the specific user is also registered. The restriction to processing is reduced as the security level becomes higher, and it is strict as the security level becomes lower. In the highest security level, each processing can be performed without restriction.

The control section 5 performs processing which has been instructed to image data. That is, depending on the input from the user or the data input from external apparatuses, each section is controlled based on the program which is stored in the storage section such as a RAM or a ROM to process the image data. The control section 5 executes either one of a copy mode, a print mode, a scanner mode, and a facsimile mode, for the image data, to output an image in a desired form.

The control section 5 functions as the control apparatus C. That is, the control section 5 authenticates the user based on user information. Then, the control section 5 is provided with an authenticating section 6. The authenticating section 6 collates the user information which has been inputted from the information processing apparatus B with the user information which has been stored in the storage section 4. Then, it is determined whether or not the user is a specific user to perform the user authentication. The specific user is a user stored in advance. When the two user information coincide with each other, the authenticating section 6 determines that the user is the specific user. When the two user information do not coincide with each other, it is determined that the user is not the specific user.

The control section 5 determines whether the use of the image processing apparatus by the user is allowed or inhibited. When the user is authenticated to be the specific user, the processing is executed. When the user is not authenticated to be the specific user, the processing is stopped.

The image processing apparatus A is provided with a network control section 7 for performing communication with external apparatuses including other image processing apparatuses or an information processing apparatus such as a PC. The network control section 7 is connected to the external apparatuses through the network or the telephone line, and is able to perform data communication and facsimile communication. The network control section 7 performs communication with external apparatuses including other image processing apparatuses or an information processing apparatus such as a PC.

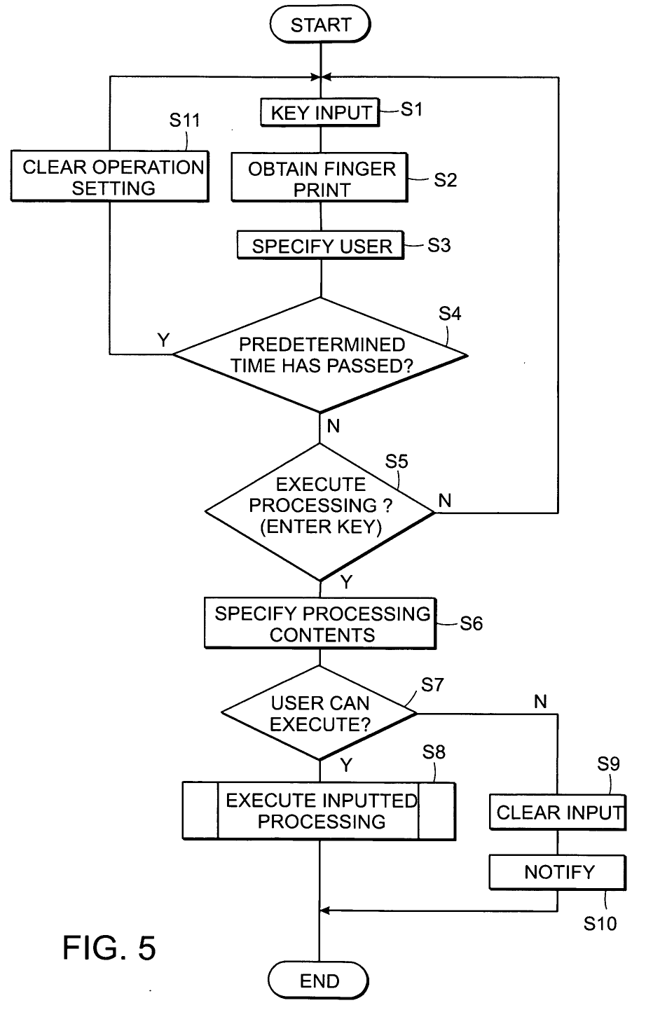

The procedure of user authentication in the present image processing system will be described in accordance with FIG. 5.

When one job is performed, the user firstly depresses the input key 14 of the inputting section 10 in the information processing apparatus C with the finger to input desired instruction (S1). In this case, the detecting section 15 reads an image of the finger to output to the control section 12. The control section 12 obtains finger print information from the image of the finger (S2). The control section 12 outputs the finger print information as user information to the control section 5 of the image processing apparatus A.

The authenticating section 6 performs authentication of the user based on the inputted user information (S3). After the user has not been authenticated, in other words, the user is not the specific user, the control section 5 inhibits the use. Thereafter, operation of the user will not be received.

After the user has been authenticated, in other words, the user is the specific user, the control section 5 allows the use. When the use is allowed, the control section 5 confirms whether or not a predetermined time, for example, 30 seconds has passed from the last operation (S4). When the predetermined time has passed, in other words, when no new operation is performed even after the predetermined time has passed from the last operation in the middle of the operation, the control section 5 cancels the operation information which has been inputted from the information processing apparatus B. That is, the contents of operation setting which has been set by the input is cleared (S11). When the user gets away from the image processing apparatus, such a situation occurs. Thereby, it is possible to prevent the next user from using without permission and therefore to prevent the leakage of confidential information.

When the predetermined time has not passed, the control section 5 confirms the presence or the absence of the input by operation of the enter key (S5). When the operation is not finished, the user continues the operation without operating the enter key. Every time the user operates, the detecting section 15 obtains finger print information, and the authenticating section 6 performs the user authentication. When the same user operates, the first user is specified each time.

Thereafter, when the enter key is operated, the control section 5 specifies the processing from the inputted operation information (S6) and determines whether or not the processing by the specified user is executable (S7). The image output including copying, facsimile transmission, data transmission, and reading of a stored image, is restricted depending on the security level of the specified user.

When it is determined to be executable, the control section 5 performs the processing (S8). When the contents of the inputted processing exceed the restriction given to the user, it is determined not to be executable. In this case, the inputted operation information is cleared (S9), which is informed to the user (S10).

When all of the processing is completed, the job is finished. The control section 5 is automatically logged out. At the time of performing a new job, user authentication is performed again.

In this way, the user performs the normal operation, and thereby automatically the user authentication is performed and the log-out is carried out simultaneously. Thus, there is not need of performing special operation for the user authentication, and the improvement of the operability can be attained.

When different finger print information is detected in the middle of the operation, the authenticating section 6 detects that it does not coincide with the finger print information of the user who has been already authenticated. The control section 5 determines not to be the specific user for the job. The control section 5 immediately inhibits the use. Thereafter, operation of the user will not be received. Such a situation occurs when the user is replaced in the middle. That is, this is the case when the user gets away from the image processing apparatus in the middle of the operation and thereafter another user operates it. Since user information of another user is different from that of the authenticated user, this user will not be authenticated. Another user can not use the image processing apparatus.

Thus, by performing the authentication a plurality of times until the operation is finished, it is made possible to deal with the abnormal situation that the user is replaced in the middle. Thereby, it is possible to prevent unauthorized uses and improve the security property.

Moreover, when the user who has been replaced in the middle is the specific user, the use may not be inhibited as described above, but be allowed. That is, the inputted finger print information is different from the existing finger print information, but is the registered finger print information. Since the replaced user is also the specific user, the authenticating section 6 authenticates the user and allows the use. Then, the control section 5 performs the processing. In this case, the control section 5 restricts the image output depending on the security level of the user who has been authenticated later. Alternatively, the image output is restricted depending on the lowest security level of a plurality of security levels of the specified user.

### Second Embodiment

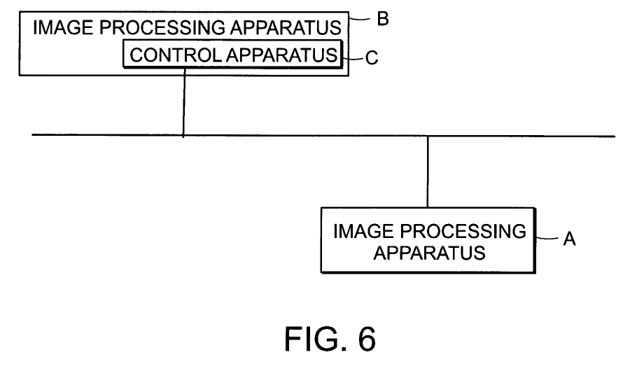

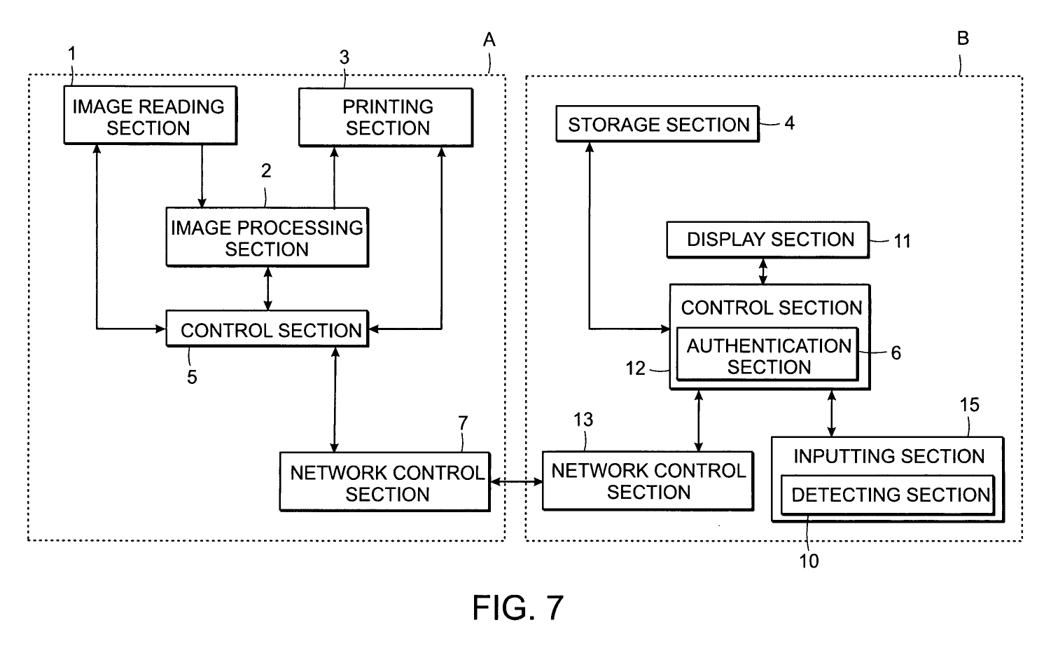

Next, a second embodiment of the present invention will be described using FIGS. 6, 7. Moreover, if any portion is same as in the first embodiment, same reference numeral is given thereto with description thereof omitted, and description will be made for different portions.

In the second embodiment, user authentication is performed by the information processing apparatus B serving as the operating apparatus. That is, the information processing apparatus B is provided with the function of the control apparatus C. Specifically, a storage section 4 of the information processing apparatus B stores user information. A controls section 12 is provided with an authenticating section 6 for performing user authentication from a detected image of the finger. Other portions are same as the first embodiment.

The control section 12 determines whether the user who has inputted is allowed or inhibited to use the image processing apparatus. When the user is authenticated to be the specific user, the user is allowed to use the image processing apparatus A. When the user is not authenticated to be the specific user, the user is inhibited to use the image processing apparatus A and the input from an inputting section 10 is canceled.

For example, when a plurality of information processing apparatuses are connected to the image processing apparatus, user authentication is performed in each information processing apparatus B, and therefore, in the image processing apparatus A, there is no need of performing the authentication for each of the inputted information. That is, only operation information which has been inputted by the authenticated user in the information processing apparatus C is inputted to the image processing apparatus. Thus, the image processing apparatus A only performs processing based on the inputted operation information, thus making it possible to reduce the processing time. Moreover, a lot of jobs can be processed quickly.

### Third Embodiment

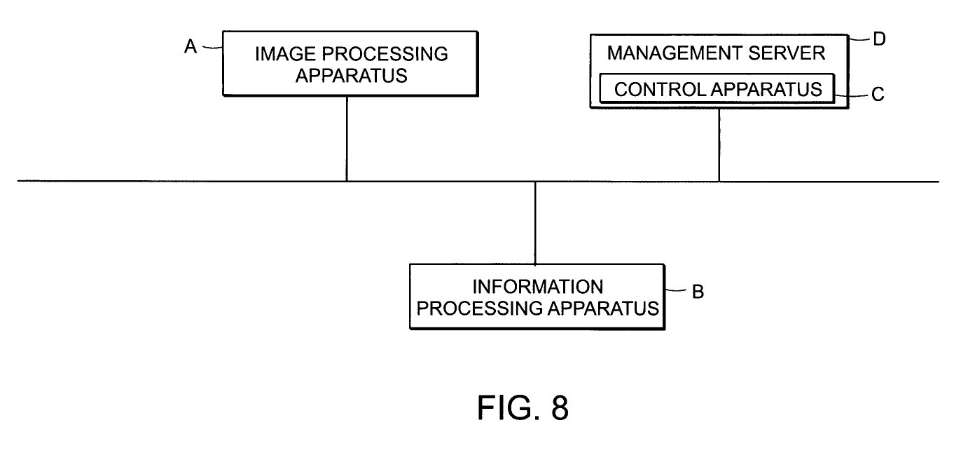

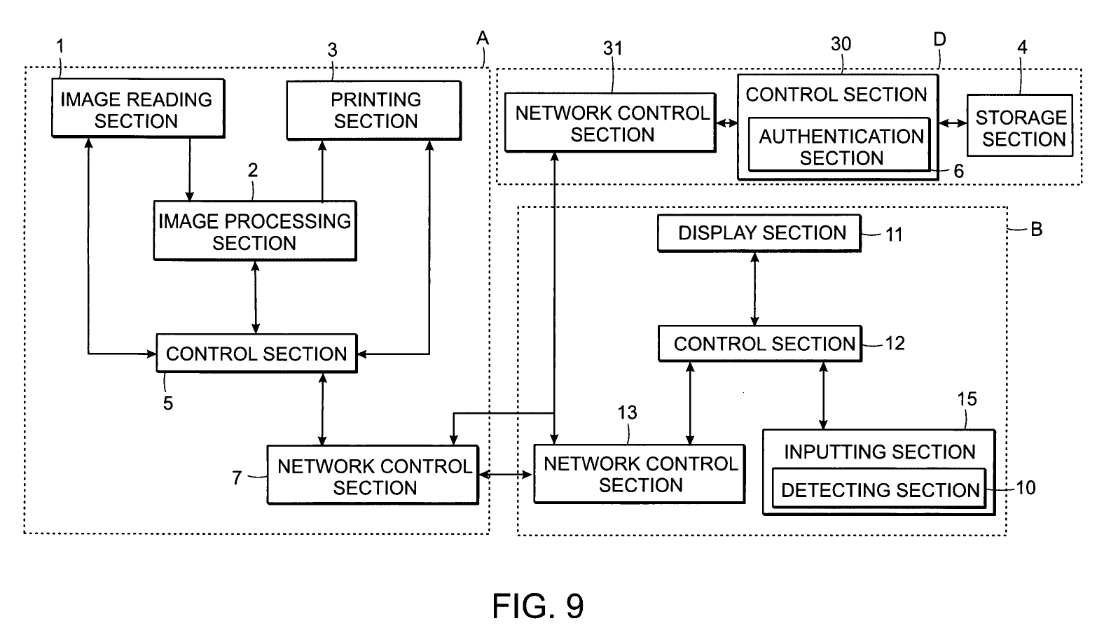

Next, a third embodiment of the present invention will be described using FIGS. 8, 9. It should be noted that, if any section is same as in the first embodiment, same reference numeral is given thereto with description thereof omitted, and description will be made for different sections.

In the third embodiment, a management server D is provided, and user authentication is performed with the management server D. That is, the management server D is provided with the function of the control apparatus C. Moreover, other portions are same as the first embodiment.

The management server D includes a storage section 4 for storing user information, a control section 30 having the authenticating section 6 for performing user authentication from a detected image of the finger, and a network control section 31 for performing communication with the image processing apparatus A and the information processing apparatus B.

The control section 30 determines whether the user who has inputted operation information from the information processing apparatus B is allowed or inhibited to use the image processing apparatus A. When the user is authenticated to be the specific user, the inputted operation information is outputted to the image processing apparatus A. When the user is not authenticated to be the specific user, the inputted operation information is canceled.

The procedure of user authentication in the present image processing system is basically same as the procedure shown in FIG. 5. The information processing apparatus B outputs an obtained image of the finger of the user and inputted operation information, to the management server D. The control section 30 of the management server D specifies the user based on inputted user information. When the user is not authenticated to be the specific user, the user is inhibited to use the image processing apparatus A and the input from an inputting section 10 is canceled. When the user is authenticated to be the specific user, the user is allowed to use the image processing apparatus A and the inputted operation information is outputted to the image processing apparatus A. The image processing apparatus A performs processing based on the inputted operation information.

It should be noted that, in the present embodiment, the inputted operation information is outputted to the management server D together with the detected user information, but which is particularly not limited thereto. For example, it may be configured so that the user information is outputted to the management server D and the operation information is outputted to the image processing apparatus A. In this case, after receiving the authentication result from the management server D or after confirming with the management server D as to whether or not the authentication has been made, the image processing apparatus A starts processing based on the inputted operation information.

### Fourth Embodiment

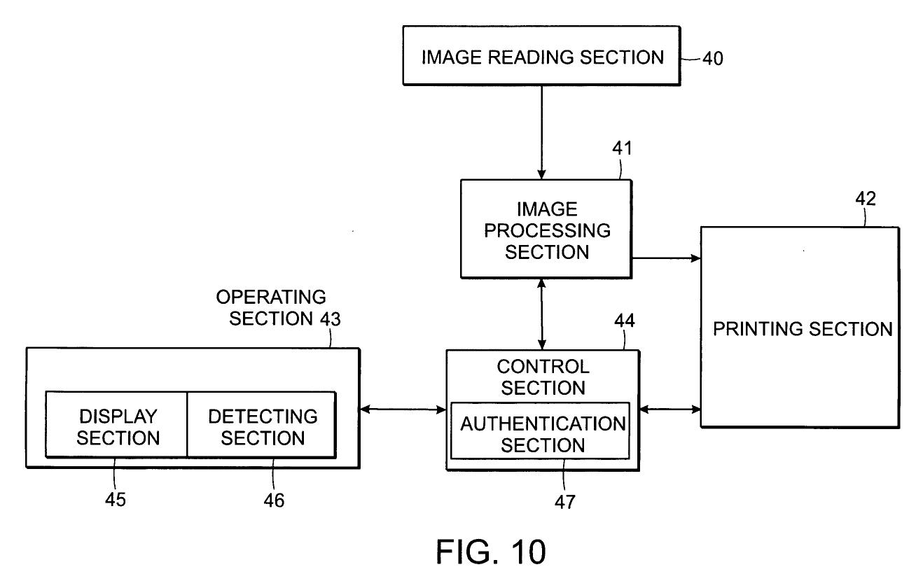

Next, an image processing apparatus A of a fourth embodiment of the present invention will be described using FIGS. 10 to 12. The image processing apparatus A of the fourth embodiment is in the case of that a processing apparatus, an operating apparatus, and a control apparatus are provided in one image processing apparatus.

Specifically, the image processing apparatus A is a multifunctional peripheral for performing processing such as copying, printing, facsimile communication, and document filing. As shown in FIG. 10, the image processing apparatus A is provided with an image detecting section 40 for reading an image of a document, an image processing section 41 for carrying out predetermined image processing for the read and inputted image, a printing section 42 for printing the image on the recording sheet, an operating section 43 for giving instruction of processing by operation of the user, and a control section 44 for controlling execution of processing with respect to the image. The image processing apparatus A is connected to a network and performs communication with external apparatuses including other image processing apparatuses and an information processing apparatus such as a PC. The image processing apparatus A is also connected to the telephone line to perform facsimile communication. Moreover, a processing section is made up of the image detecting section 40, the image processing section 41, and the printing section 42.

The operating section 43 is an input display which is formed by integrating a display and a scanner. The operating section 43 includes a display section 45 for performing display for operation on the screen, and a detecting section 46 for detecting an image of an object on the screen.

A liquid crystal display is used for the display section 45. The detecting section 46 irradiates the object on the screen with light and detects the reflected light with an optical sensor to read the image of the object. The object on the screen includes not only an object which is in contact with the screen, but an object which is placed above a little away from the screen. That is, the detecting section 46 can detect an image of an object near the screen. Moreover, the input display is described in detail, for example, in Japanese Patent Laid-Open Nos. 2004-153327 and 2006-167039.

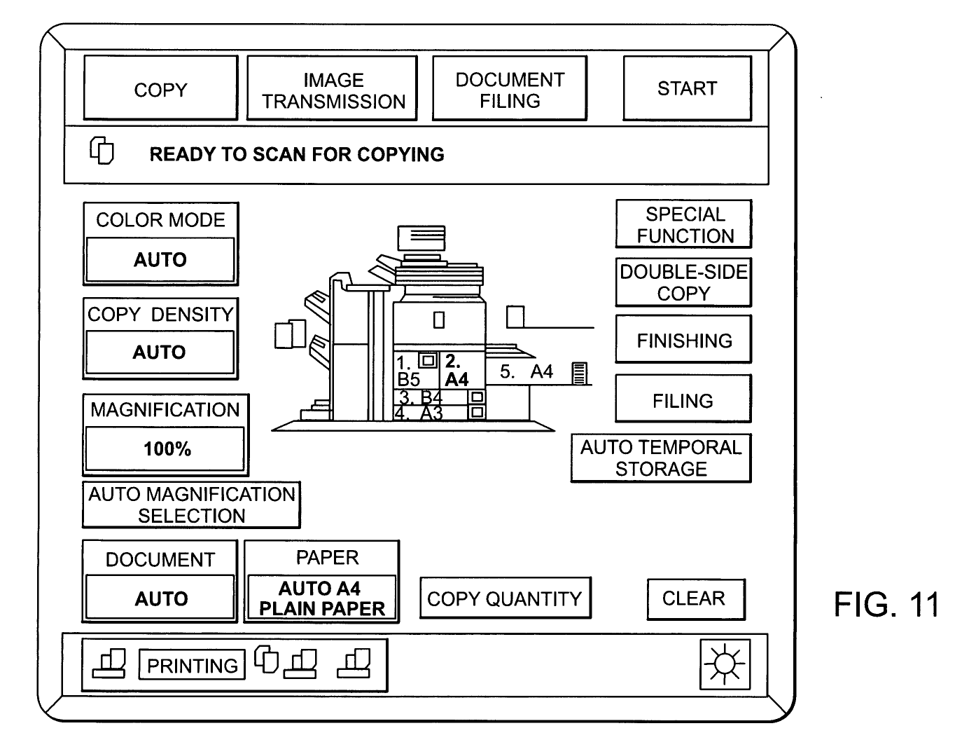

As shown in FIG. 11, operation keys for performing various kinds of settings and operation instructions are displayed by the display section 45 on the screen of the operating section 43. When the user touches the operation key on the screen with the hand, the detecting section 46 detects an image of the hand of the user. The position where the user has touched is detected from the image of the finger which is in contact with the screen. Then the detecting section 46 recognizes the contents of the operation key corresponding to the position to input instruction in accordance with the contents to the control section 44. In this case, the detecting section 46 extracts finger print information of the user from the detected image of the finger and inputs the finger print information to the control section 44 as user information.

The control section 44 has an authenticating section 47 for authenticating the user based on the user information. The authenticating section 47 collates the user information which has been inputted from the operating section 43 with the user information which has been registered in advance. Then, it is determined whether or not the user is a specific user to perform the user authentication. The specific user is a user registered in advance. When the two user information coincide with each other, the authenticating section 47 determines that the user is the specific user. When the two user information do not coincide with each other, it is determined that the user is not the specific user.

The control section 44 determines whether the use of the image processing apparatus A by the user is allowed or inhibited. When the user is authenticated to be the specific user, the use is allowed, and when the user is not authenticated to be the specific user, the use is inhibited.

The operating section 43 detects user information from the hand of the user every time the user performs operation. The authenticating section 47 performs the authentication every time user information is inputted from the operating section 43. The authentication is repeatedly performed until the start key on the screen is operated. Here, when the user is replaced, the inputted user information does not coincide with the user information of the user who has been already authenticated. When detecting that the user has been replaced, the control section 44 determines whether allowing or inhibiting the use depending on the replaced user.

Then, the control section 44 performs the user authentication in the unit of a job. When a job is finished, the control section 44 is logged out. Even when the user does not perform special operation, it is automatically logged out.

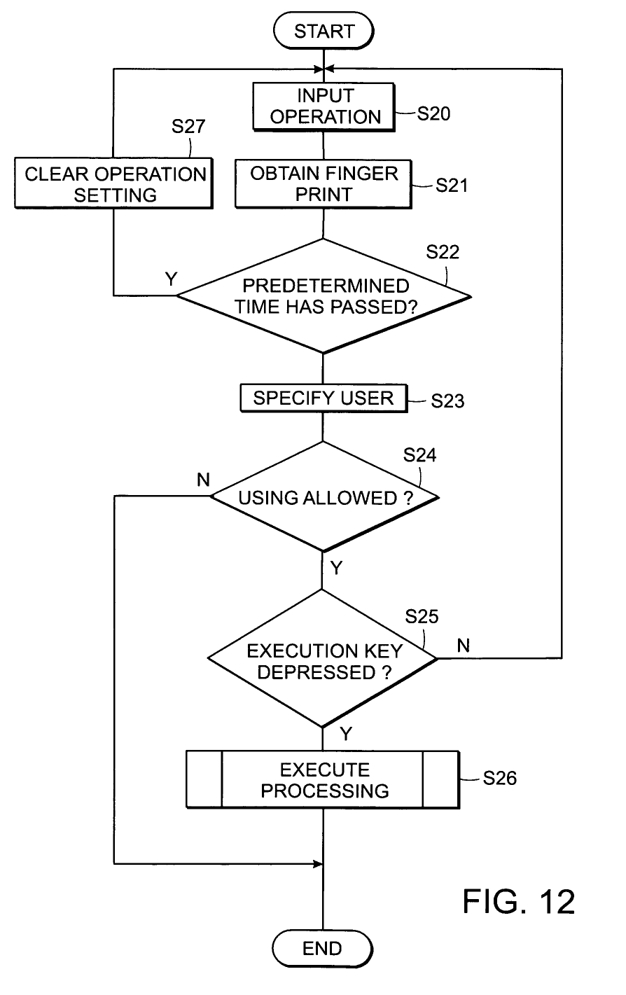

The procedure of user authentication in the present image processing apparatus A will be described in accordance with FIG. 12. When one job is performed, the user firstly touches an operation key on the screen of the operating section 43 with the finger to input desired instruction (S20). In this case, the detecting section 46 reads an image of the finger to obtain finger print information from the image (S21). The detecting section 46 inputs the finger print information to the control section 44 as the user information.

When the operation above is performed, the control section 44 confirms whether or not a predetermined time, for example, 30 seconds has passed from the last operation (S22). When the predetermined time has not passed, the authenticating section 47 specifies the user based on the inputted user information (S23). The control section 44 determines whether allowing or inhibiting the use (S24).

When the user is not the specific user, the control section 44 inhibits the use. Thereby, operation of the user will not be received. When the given time has passed, the control section 44 allows to receive operation.

Moreover, when the clear key is operated, the control section 44 receives operation. The user can perform the operation again. That is, a reading error has occurred, user information can not be detected correctly in the detecting section 46. In this case, by operating the clear key, it is possible to turn into the operable state immediately.

When the user is the specific user, the control section 44 allows the use. The control section 44 confirms whether or not the start key has been operated (S25). When the operation is not finished, the user continues the operation without operating the start key. Every time the user performs operation, the detecting section 46 obtains finger print information and the authenticating section 47 performs user authentication. When same user operates, the first user is specified every time.

Thereafter, when the start key is operated, the control section 44 performs the processing set by the operation (S26). In this case, the image output including copying, facsimile transmission, data transmission, and reading of a stored image, is restricted depending on the security level of the specified user.

When all of the processing is completed, the job is finished. The control section 44 is automatically logged out. At the time of performing a new job, user authentication is performed again. In this way, the user performs the normal operation, and thereby the user authentication is performed and the log-out is carried out, automatically. Thus, there is no need of performing special operation for the user authentication, and it is made possible to attain the improvement of the operability.

When different finger print information is detected in the middle of the operation, the authenticating section 47 detects that it does not coincide with the finger print information of the user who has been already authenticated, and thereafter determines that the user is not the specific user for the job. The control section 44 inhibits the use immediately. Thereafter, operation of the user will not be received.

Such a situation occurs when the user is replaced in the middle. That is, this is the case when the user gets away from the image processing apparatus A in the middle of the operation and thereafter another user operates it. Since user information of another user is different from that of the authenticated user, this user will not be authenticated. Another user can not use the image processing apparatus A.

Thus, by performing authentication a plurality of times until the operation is finished, it is possible to handle the abnormal situation that the user is replaced in the middle. Thereby, it is possible to prevent unauthorized uses and to improve the security property.

Moreover, when another user who has been replaced in the middle is the specific user, the use may not be inhibited as described above, but be allowed. That is, the inputted finger print information is different from the existing finger print information, but is the registered finger print information. Since the replaced user is also the specific user, the authenticating section 47 authenticates the user and allows the use. Then, the control section 44 performs the processing. In this case, the control section 44 restricts the image output depending on the security level of the user who has been authenticated later. Alternatively, the image output is restricted depending on the lowest security level of a plurality of security levels of the specified user.

Further, when no new operation is performed even after a predetermined time has passed from the last operation in the middle of the operation, the control section 44 cancels the input from the operating section 43. That is, the contents set by the operation is cleared (S27). When the user gets away from the image processing apparatus A, such a situation occurs. Thereby, it is possible to prevent a subsequent user from using without permission and therefore to prevent the leakage of the confidential information.

### Fifth Embodiment

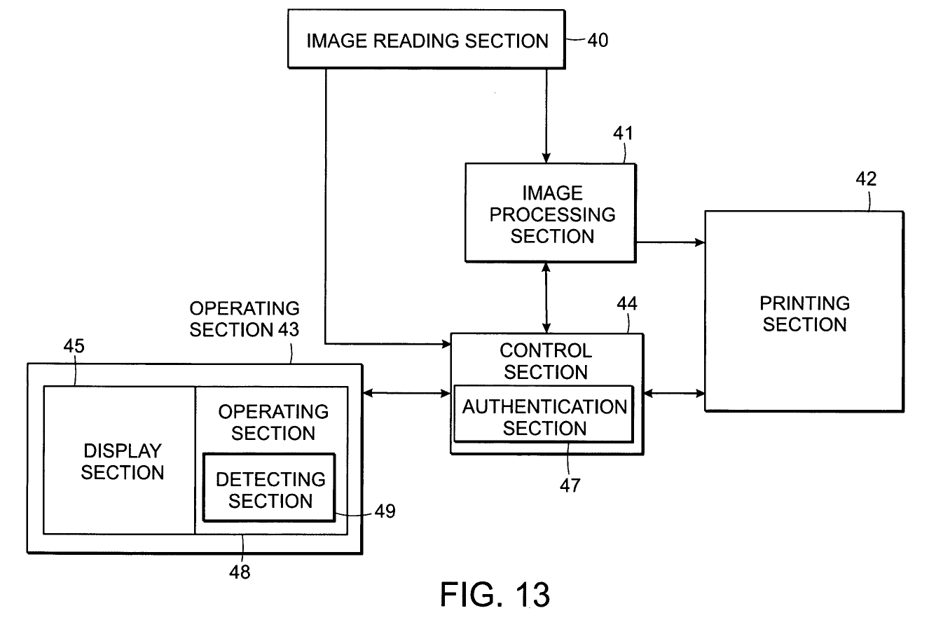

Next, an image processing apparatus A of a fifth embodiment of the present invention will be described using FIGS. 13 to 16. Like in the fourth embodiment, the present embodiment shows the case that a processing apparatus, an operating apparatus, and a control apparatus are provided in one image processing apparatus. It should be noted that, if any section is same as in the fourth embodiment, same reference numeral is given thereto with description thereof omitted, and description will be made for different portions.

In the fifth embodiment, as shown in FIG. 13, an operating section 43 for setting operation of the image processing apparatus A is provided with an execution key 48a for carrying out determination of operation input and instruction to execute operation, and the execution key 48a functions as the last operation key for each job unit and constitutes a part of a user authentication system. That is, an inputting section 48 for carrying out the determination of operation input and the instruction to execute a job constitutes a part of the user authentication system. Moreover, other portions are same as the fourth embodiment.

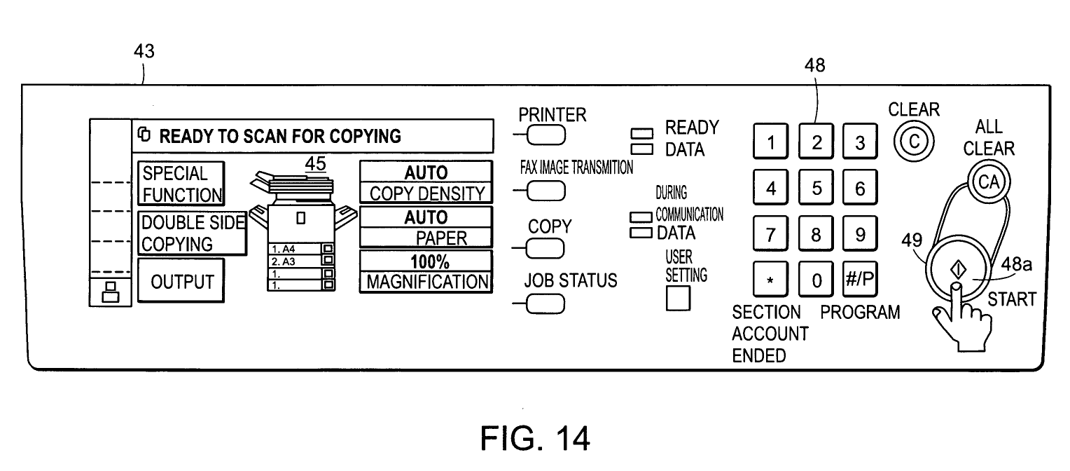

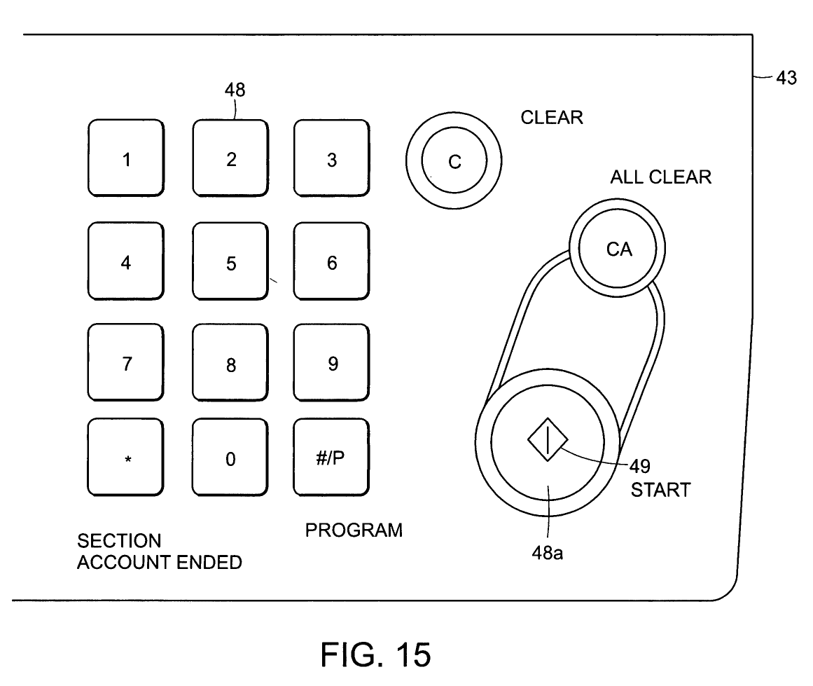

As shown in FIGS. 14 and 15, the operating section 43 is provided with a display section 45, and an inputting section 48 in which a plurality of input keys are arranged.

The display section 45 is made up of a liquid crystal display and displays inputted contents and the operation state of the whole of the image processing apparatus A. A general touch panel is provided on the surface of the display section 45 and is capable of inputting through the touch panel.

The inputting section 48 which is a keyboard including various kinds of input keys performs inputting of operation information such as operation instructions and various kinds of settings. The input key is provided with the execution key 48a which functions as the last operation key for each job unit.

The execution key 48a is a key which is lastly depressed when the user instructs execution of copying, transmission of image data, and reading of image data. A detecting section 49 for detecting an image of the finger of the user, which has depressed the key, is provided on the center of the upper face of the execution key 48a.

The detecting section 49 is configured to be an image sensor (CCD) and reads the image of the finger of the user quickly. The read image of the finger is outputted to the control section 44. Every time the user depresses the execution key 48a, the detecting section 49 performs surface-scan of the finger print of the user to read the finger print. The authenticating section 47 performs authentication every time user information is inputted from the execution key 48a.

Here, when the user is replaced, the inputted user information does not coincide with the user information of the user who has been already authenticated. When detecting that the user has been replaced, the control section 44 determines whether allowing or inhibiting the use depending on the replaced user.

Then, the control section 44 performs user authentication in the unit of a job. When the job is finished, the control section 44 is logged out. Even when the user does not perform special operation, it is automatically logged out.

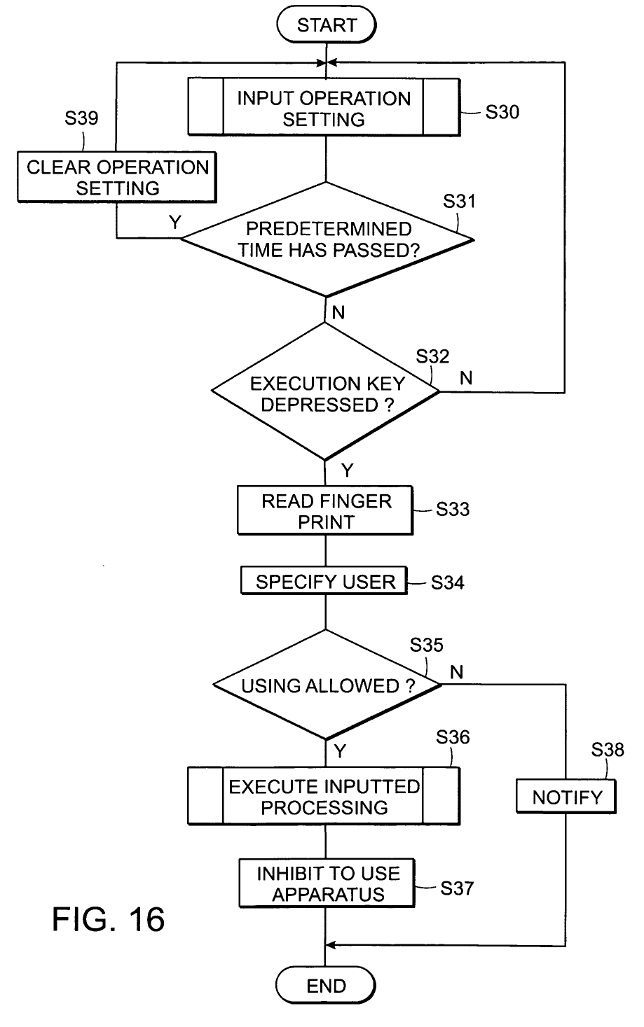

The procedure of user authentication in the present image processing apparatus A will be described in accordance with FIG. 16. The user uses the operating section 43 to perform inputting of setting such as the copy quantity and variable magnification settings, without performing user authentication before the start of using the image processing apparatus A (S30).

At the time of performing operation setting by the user, the time from the first operation of the input key to the depression of the execution key 48a, by the user, is measured, and when the key operation has not been performed for a predetermined time, for example, 30 seconds (in the case of Y at S31), it is recognized that the user performing the operation setting gets away from the apparatus and the setting contents being subjected to the operation setting is cleared to return the setting of the apparatus into an initial state (S39). Moreover, the predetermined time that the key operation has not been performed is not limited to 30 seconds above, but can be selected as appropriate.

When the copying condition is set from the operating section 43 and the execution key 48a is depressed within the predetermined time (in the case of Y at S32), the finger print of the user is obtained at the detecting section 49 provided in the execution key 48a (S33). In a state where the execution key 48a is being depressed, the surface of the finger of the user is surely in contact with the detecting section 49, thus it is made possible to surely read the finger print of the user.

The read finger print information and the user information which has been registered in the apparatus in advance are compared with each other to specify the user (S34). Thereby, it is determined whether allowing or inhibiting the copying (S35).

Further, when the user is specified (S34), the security level for the user can be specified, thus it is made possible to restrict FAX transmission, mail transmission, FTP transmission, or outputting of image data stored in the apparatus, depending on the level of the user.

When the use of the apparatus (copying) is not allowed by the finger print authentication (in the case of N at S35), a message to that effect is displayed on the display section 45 and the user authentication of the apparatus is cleared.

When the use of the apparatus (copying) is allowed by the finger print authentication (in the case of Y at S35), processing such as copying and transmission is performed based on the setting contents set from the operating section 43 (S36).

Then, the user authentication of the apparatus is cleared (S37), and thereby user authentication is performed by depressing the execution key 48a when new processing is performed. Thus, it is configured so that the user authentication is performed in the unit of a job of the execution key 48a, and it is possible to surely perform copy processing and the like.

In this way, with one depression of the execution key 48a, the user authentication is performed simultaneously, and therefore user authentication can be performed for each processing and copy processing or processing restriction can be performed surely, thus making it possible to improve the security of the apparatus.

The present invention will not be limited to the above described embodiments and many modifications and alterations can certainly be made to the above described embodiments within the scope of the present invention. Further, the user authentication system of the present invention may be used not only for an image processing system, but also, for example, for various systems in which an operating apparatus and a processing apparatus are connected through a network, such as a robot control system, a remote control system, and a care support system.

As user information, vein information of the finger may be used in place of the finger print of the user. Alternatively, a part of the human body by which inputting is performed to an inputting section, in other words, biological information, including iris information when the inputting section is a visual line operating apparatus, and voice pattern information when it is a voice operating apparatus, may be used.

For example, in the present embodiment, although finger print information is extracted from the detected image of the finger and thereafter outputted to the authenticating section, but without any particular limitation, the detected image of the finger may be outputted to the authenticating section as it is. Alternatively, it may be configured so that successive lines are detected from the detected image of the finger to extract finger print information and output to the authenticating section.

Moreover, the processing apparatus, the operating apparatus, and the control apparatus are not limited to be image processing systems each of which is independent, and, for example, the processing apparatus, the operating apparatus, and the controlling apparatus may be provided in one image processing apparatus. It may be configured so that the processing apparatus is included in the operating apparatus and the control apparatus is provided in the external apparatus.

What is claimed is:

1. A user authentication system, comprising:
a processing apparatus for processing image data;
an operating apparatus which is operated by a user to instruct processing in the processing apparatus; and
a control apparatus capable of communicating with the processing apparatus and the operating apparatus, wherein
the operating apparatus has a detecting section for obtaining user information of the user while the user is operating the operating apparatus, and
the control apparatus performs authentication of the user based on the user information.

2. The user authentication system according to claim 1, wherein:
the operating apparatus has an inputting section which is touched by the user;
the detecting section is provided in the inputting section,
the detecting section detects an image of a finger of the user; and
the operating apparatus outputs instruction in accordance with contents of the operated inputting section to the control apparatus and outputs the finger image of the user as the user information to the control apparatus.

3. The user authentication system according to claim 2, wherein:
an image pickup device is provided in the inputting section as the detecting section, and
the detecting section obtains the image of the user's finger in contact with the inputting section.

4. The user authentication system according to claim 1, wherein:
the control apparatus allows the processing by the processing apparatus after the user has been authenticated, and inhibits the processing by the processing apparatus after the user has not been authenticated.

5. The user authentication system according to claim 1, wherein:
the control apparatus performs authentication every time the user operates.

6. The user authentication system according to claim 5, wherein:
when it is detected based on the inputted user information that the user has been replaced, the control apparatus determines whether allowing or inhibiting a use depending on a replaced user.

7. The user authentication system according to claim 6, wherein:
the control apparatus performs the authentication of the user in the unit of a job.

8. The user authentication system according to claim 1, wherein:
after the user information has been inputted from the operating apparatus, if no inputting has been performed from the operating apparatus for a predetermined time has passed, the control apparatus clears the instruction by the operating apparatus.

9. An image processing apparatus, comprising:
a processing section for processing image data;
an operating section for setting operation of the processing section; and
a control section for controlling the processing section depending on an input from the operating section, wherein
the operating section detects user information from a user while the user is operating, and
the control section performs authentication of the user based on the user information.

10. The image processing apparatus according to claim 9, wherein:
the operating section has a display section for performing display for operation on a screen and a detecting section for detecting an image of an object on the screen, and
the operating section detects a position where the user has pointed, inputs instruction in accordance with contents displayed on the position to the control section, and inputs an image of an operating hand of the user as the user information to the control section.

11. The image processing apparatus according to claim 9, wherein:
the operating section is provided with an execution key for performing determination of operation input and instruction to execute operation, and a user authenticating section which is operated by a key operation of the execution key, and
the execution key functions as a last operation key for each job, and user authentication is performed by the operation of the execution key.

12. The image processing apparatus according to claim 11, wherein:
the execution key is a start key.

13. The image processing apparatus according to claim 11, wherein:
an image pickup device for the user authentication is provided on an upper face of the execution key as the user authenticating section, and
the image pickup device is operated by a depressing operation of the execution key.

14. The image processing apparatus according to claim 13, wherein:
the image pickup device is a CCD camera.

15. The image processing apparatus according to claim 9, wherein:
the control section performs the authentication every time the user operates.

16. The image processing apparatus according to claim 15, wherein:
when it is detected based on the inputted user information that the user has been replaced, the control section determines whether allowing or inhibiting a use depending on a replaced user.

17. The image processing apparatus according to claim 15, wherein:
the control section performs the authentication of the user in the unit of a job.

18. The image processing apparatus according to claim 17, wherein:
the control section performs a log-out after the end of a job.

19. The image processing apparatus according to claim 15, wherein:
the control section cancels the input from the operating section after a predetermined time has passed from a last operation.

20. The image processing apparatus according to claim 19, wherein:
the control section performs the processing when the execution key is operated within the predetermined time from the last operation.
